(19) United States
(12) Patent Application Publication
(10) Pub. No.: US 2022/0412834 A1
(43) Pub. Date: Dec. 29, 2022

(54) FIBER OPTICS SENSOR FOR HYDROCABON AND CHEMICAL DETECTION

(71) Applicant: SHAWCOR LTD., Toronto (CA)

(72) Inventors: DILIP TAILOR, Toronto (CA); JACQUES ALBERT, Toronto (CA); RONALD J. DUNN, Toronto (CA); MARK PHILLIP BRANDON, Toronto (CA)

(21) Appl. No.: 17/778,850

(22) PCT Filed: Nov. 20, 2020
(86) PCT No.: PCT/CA2020/051589

§ 371 Date: May 22, 2022

Related U.S. Application Data
(60) Provisional application No. 62/939,196, filed on Nov. 22, 2019.

(51) Int. Cl. G01M 3/04

(52) U.S. Cl. CPC G01M 3/04

(57) ABSTRACT

Described is a fiber optic cable useful as a sensor for the detection of water or hydrocarbons. The fiber optic cable has sensor portions in line with fiber optic portions; the refractive index of the sensor portion changes when the sensor portion is placed in contact with water or hydrocarbons.

### FIELD OF THE INVENTION

The invention relates to fiber optic sensors for hydrocarbon and chemical detection.

### BACKGROUND OF THE INVENTION

Hydrocarbon pipeline spills are of increasing concern. Although hydrocarbon pipeline is typically made of steel with anti-corrosion coatings, external factors such as impact, coating damage, water ingress, etc., as well as the often corrosive and volatile nature of the hydrocarbon being transported may lead to failure, typically through corrosion. Such failure may lead to leaking of hydrocarbon out of the pipeline and into the environment. The location of such leaks cannot be easily predicted in advance. Where such leaks occur in remote locations, they are often not detected early enough to prevent significant hydrocarbon spills, leading to costly environmental damage.

There are currently a number of systems for the detection of such leaks. The most common is to utilize existing flow and pressure meters and sensors to detect changes in flow or pressure of the transported hydrocarbon. The challenge with such systems is that changes in flow or pressure occur for many reasons, most of which are not related to a leak. Often complex computer-based algorithms have therefore been developed, with mixed success. Currently, typically, such systems are able to detect only very large leaks, in order of, for example, a leak rate of 200,000 litres/hour for a 16 inch pipeline.

Fiber optic—based monitoring systems are also available from a variety of providers, including Optasense (UK), Omnisens (Switzerland), HiFi Engineering (Canada), Cementys (France), Honeywell International Inc. (USA), FISO Technologies Inc. (USA), Silixa (UK), Prime Photonics (USA), Sensornet Ltd. (UK), and many others. Generally, these systems utilize measurement of changes in light transmission and/or reflection over the length of the fiber optic cable, using the technique commonly referred to as “distributed sensing”. These optical fiber systems respond to environmental changes by way of changes in strain, acoustics and/or temperature, all of which affect the light signal going through the fiber optic cable. Using algorithms and computations, these system attempt to deduce the presence of a hydrocarbon, using changes in strain, acoustics and/or temperature as indicators. As would be understood, changes to the strain, acoustics and/or temperature could happen due to numerous events, such as rain, snow, ground movements, distant seismic events etc. Therefore it is generally accepted in the industry that there are typically many false positive oil spill alerts from these indirect leak detection systems, regardless of the complexity of the algorithms and computations.

Known fibre optic cable is generally shown, in schematic form, in FIG. 1. The optical fibre cable 200 comprises an inner core 22, typically made of high purity doped glass (silica), surrounded by a cladding 24. Cladding 24 is typically a glass layer having a lower refractive index than core 22, to maintain guidance of light within the core 22, meaning that the transmitted light is reflected back in the core 22 at the core/cladding interface 23 and is propagated forward in the core 22. The cladding 24 effectively “reflects” stray light back into the core 22, ensuring the transmission of light through the core 22 with minimal loss. This is essentially achieved with a higher refractive index in the core 22 relative to the cladding 24, causing a total internal reflection of light. The cladding 24 is typically further encapsulated by a single or multiple layers of primary polymer coatings, such as acrylates and polyimides, also known as buffer coating 26, for protection and ease of handling. The buffer coating 26 serves to protect the fiber from external conditions and physical damage. It can incorporate many layers depending on the amount of ruggedness and protection required.

Optionally, an outer protective sheath 27 may also be present, which can be made from a wide variety of materials, the purpose of which is further protection and ease of handling. In certain known embodiments, core 22 can be of about 8 microns in diameter, with cladding 24 of a diameter of about 125 microns, buffer coating 26 of about 250 microns in diameter, and an outer sheath 27 or jacket of about 400-3000 microns in diameter.

Known optical fibers are generally categorized into two different types—single mode, intended for long distance communications, and multimode for short haul communications. Multimode fibers have a larger core 22, typically about 62.5 microns in diameter, while the single modes have cores 22 of about 8 microns.

When used in sensor applications, multimode fibers are sometimes used for temperature sensing, whilst single mode fibers are mostly used for distributed acoustic sensing or strain sensing as well as for temperature.

Fundamentally, a fiber-optic sensor works by modulating one or more properties of a propagating light wave, including intensity, phase, polarization, and frequency, in response to the environmental parameter being measured. In its simplest form, an optical fiber sensor is composed of a light source, optical fiber, sensing element, and detector (an interrogator).

A variety of optical sensing technologies have been developed over the years and are now readily available on the market. Among these are Fabry-Perot interferometers, fiber Bragg gratings (FBG), including uniform FBGs, long period gratings (LPGs), tilted FBGs, chirped FBGs, and superstructure FBGs, and distributed sensors based on Rayleigh, Raman, and Brillouin optical scattering techniques. Sensing technologies have also been developed utilizing tapered fiber optics.

Truly distributed fiber-optic sensing systems use the entire fiber length to sense one or more external parameters which can be on the order of several tens of kilometers. This is a capability unique to fiber-optic sensors and one that cannot be easily achieved using conventional electrical sensing techniques.

The concept of “distributed sensors” measures the scattered light at every location along the fiber. Different types of scattering exist, including Rayleigh, Brillouin, and Raman scattering.

Rayleigh, the most dominant type of scattering, is caused by density and composition fluctuations created in the material during the manufacturing process. Rayleigh scattering occurs due to random microscopic variations in the index of refraction of the fiber core. When a short pulse of light is launched into a fiber, the variation in Rayleigh backscatter as a function of time can help determine the approximate spatial location of these variations. Although Rayleigh scattering is relatively insensitive to temperature, it can still be used as a distributed sensing technique for temperature and strain.

Raman scattering is caused by the molecular vibrations of glass fiber stimulated by incident light. The resulting scatter has two wavelength components, one on either side of the main exciting light pulse wavelength, called Stokes and anti-Stokes. The ratio between Stokes and anti-Stokes is used for temperature sensing, and is immune to strain. This technology is popular in downhole oil and gas applications for profiling temperature variations in oil wells.

A third type of scattering is Brillouin, which stems from acoustic vibrations stimulated by incident light. To satisfy the requirement of energy conservation, there is a frequency shift between the original light pulse frequency and the Brillouin scattered wave. This frequency shift is sensitive to temperature and strain, so it enables the profiling of temperature and stress variations throughout the length of the fiber. However, differentiating between temperature and strain can be difficult. Special sensor packaging and the combination of Brillouin with other sensing technologies (such as Raman or FBG) can help separate the two physical phenomena.

It is noted that in such distributed fiber optics system, the optical responses are caused by changes in temperature, pressure, vibration, or other strain on the optical fiber, which are then used as proxy for hydrocarbon leaks. As can be appreciated, such changes can be caused by a wide variety of factors, for example, due to the soil and pipe movements, traffic load and noise on the ground above, temperature fluctuation in the soil, rain, frost, distant seismic activities, etc. It is also noted that these distributed sensing fiber optic cables cannot directly detect a hydrocarbon leak. Such systems are often used in combination with the internal pipeline flow/pressure sensing described above, typically providing only marginal albeit measurable improvements to detection. These systems are notorious for giving false-positive leak detection alerts, triggered by events other than a leak.

Certain of these fiber optic systems utilize Fiber Bragg Gratings introduced within the fiber optic cable. This permits the measure of changes in temperature or strain on the fiber optic cable by measuring a change in the wavelength of light reflected back to the light source.

Fiber Bragg Gratings (FBGs) are made by laterally exposing the core of a single-mode fiber to a periodic pattern of intense ultraviolet light or other methods. The exposure produces a permanent increase in the refractive index of the fiber's core, creating a fixed index modulation according to the exposure pattern; this fixed index modulation is referred to as a grating.

At each periodic refraction change a small amount of light is reflected. All of the reflected light signals combine coherently to one large reflection at a particular wavelength when the grating period is approximately half the input light's wavelength. This is referred to as the Bragg condition, and the wavelength at which this reflection occurs is called the Bragg wavelength. Light signals at wavelengths other than the Bragg wavelength, which are not phase matched, are essentially transmitted without significant loss or reflection. The Bragg condition results in a peak reflection at a wavelength defined by 2× the spacing of grating fringes times the effective refractive index of the light guided by the core (the Bragg wavelength). Thus the peak wavelength of the reflected component satisfies the Bragg relation:

λref1=2nΛ,

with n being the effective index of refraction of the core-guided light wave and Λ the period of the index of refraction variation of the fiber Bragg grating. Due to the temperature and strain dependence of the parameters n and Λ, the wavelength of the reflected component will change as a function of strain (typically caused by temperature, pressure, vibration, or bending of a structure in which a FBG is fixed) “shifting” the peak reflection wavelength based on strain at the location of the grating. This is illustrated in FIG. 2.

As can be appreciated, the wavelength of the peak reflection changes every time there is a temperature or strain delta, including temperature/strain deltas caused by other sources. For instance, hydrocarbon leaks in the vicinity of the FBG might cause some changes in temperature or vibration, that could trigger a reaction in the FBG, however one cannot be certain as to the original cause. Thus, one of the key difficulties with FBG fiber optic sensors is the decoupling of the various parameters (e.g. temperature, strain) and the fact that the light propagating in the core is isolated from the surrounding medium by the thickness of the cladding glass and thus insensitive to changes in the materials surrounding the fiber. Like any other sensing technology, it is important to understand the various parameters that could influence the readings from the sensor.

Typically, when used in the art, the term FBG refers to uniform Fiber Bragg Gratings, wherein the gratings are perpendicular to the length of the fiber optic cable (and therefore to the light path), and where the grating has a uniform period/grating length. Other forms of FBGs are also known, these include Chirped FBG, tilted FBG, blazed FBG and tapered FBG. Tilted FBGs (TFBGs) are particularly sensitive to the surrounding refractive index outside the gratings. In TFBGs, core-guided light is coupled between the forward propagating core mode to backward propagating core mode (Bragg), but also between the forward propagating core mode and backward propagating cladding modes. Therefore, both a core mode resonance (i.e. a dip in the transmission spectrum) and a number of cladding mode resonances appear simultaneously. Using the core mode back reflection as a reference wavelength in the single mode fiber, it is possible to measure the perturbations such as surrounding refractive index using the cladding mode resonance shift without interference from perturbations that affect the core and cladding simultaneously, such as strain, vibration, and temperature. Because of this, the sensitivity and the discrimination from other perturbations (accuracy) of TFBG to changes in the surrounding media is improved.

When the light from the core mode hits each grating plane of a traditional FBG at normal incidence, it is reflected backwards; however with the tilted FBG where the grating planes are tilted, light is reflected off axis and each grating plane reflects a small portion of light towards the cladding. This increases the growth of the backward propagating cladding mode at phase-matched wavelengths (similar to the Bragg condition for the core, but in this case, towards the cladding). The cladding modes that will have the strongest coupling are then determined by the tilt angle.

A particular feature of tilted fiber Bragg gratings is that they are sensitive to the surrounding refractive index outside the gratings, as a result of which they can function as refractometers.

Fiber optic sensing systems utilizing tapered fiber have been described where core guided light also escapes into the cladding due to tapering. Tapering of the fiber can provide a “tilted FBG”—like effect, where the refractive index of the cladding, and changes therein, can influence the transmission characteristics of the taper. However, the transmission spectrum of a tapered fiber is not resonant in the sense of phase matching and its transmission changes are spectrally broad and difficult to distinguish from power source fluctuations, whereas such fluctuations can be referenced out in TFBGs by measuring relative shifts between multiple narrow spectral resonances.

U.S. Pat. No. 4,386,269 (incorporated herein by reference), to Avon Rubber Company Limited, describes a pipeline leak detection system utilizing fiber optic lines. This system is distinguished from the currently commercially available fiber optic systems described above, in that it is designed to measure oil leaks directly, rather than through indirect proxies such as changes in temperature or pressure on the fiber optic cable. The patent describes a fiber optic cable comprising a fiber optic core surrounded by a medium acting as the cladding and of which the refractive index is altered by the influence of a leaked hydrocarbon, for example, a silicone rubber of which the refractive index is normally lower than that of a silica fiber optic, but of which the index increases to that of the silica or above that of the silica when oil soaks into it through a permeable coating and elastomeric protective layer. When the refractive index of the silicone rubber exceeds that of the silica core, light escapes from the core and a loss is registered in the transmitted power. The detection system utilizes a light emitter at one end of the fiber optic cable, and a light receiver at the other end, which measures the light received. A difference in refractive index will cause the light to escape the core and be absorbed at the wall of the fiber optic cable, rather than transmitted to the light receiver; such difference in light received is indicative of such change in refractive index of the cable, suggesting a leak. While the concept of using the change in the refractive index as one of the causative factors is a valuable advancement in as far as responding to a presence of a hydrocarbon directly, a shortcoming of this system is that the fiber optic cable is still exposed to normal triggers like the temperature, strain and vibration. It is essentially a fiber optics system (as described above), with the shortcomings of same, without the location detection. Therefore, the signal analyzer would receive signals indicating some disturbance in the fiber, but may not be able accurately delineate the cause of the disturbance, and not its location within the length of fiber between a source and a detector.

PCT/CA2019/050253, to Dilip Tailor et. al., teaches a novel design whereby the advantageous feature of the Avon's U.S. Pat. No. 4,386,269 on the use of an oil sensitive coating is utilized while minimizing the effects of the secondary triggers like temperature and strain associated with distributed system. This was achieved by applying the oil sensitive coating over a FBG sensor. Utilizing long period fiber Bragg gratings (LPFG) was found to improve the functionality of the sensor. The LPFGs were typically inscribed in the core of an optical fiber creating a periodic refractive index modulation with a few centimeters along the fiber. The gratings enable coupling of light from the propagating core mode to the co-propagating cladding modes at discrete wavelengths, producing a series of attenuation bands in the transmission spectrum. The resonant wavelength changes with the refractive index of the environment surrounding the gratings. In a single-mode fiber, the transmission spectrum has dips at the wavelengths corresponding to resonances with various cladding modes. Like FBGs, LPFGs provide different light transmission spectrum based on both refractive index of the fiber optic cable, and the distance between grating fringes. Furthermore, several LPGs can be positioned along a given fiber length and prepared to as to have different resonance wavelength. This enables the determination of the location of the leak by the correspondence between which resonance wavelength changes and the predetermined location of the LPG associated with its resonance wavelength.

The chemical sensitivity of LPG can be explained in terms of refractive index (RI). LPG's sensitivity to the refractive index of the material surrounding the cladding (or the core) in the grating region can be employed to develop it as chemical sensor. The position and strength of attenuation band depends on effective refractive index of the cladding modes, which in turn depends on the refractive index of the surrounding environment. It enables the use of LPG's as index sensors based on the change in wavelength and/or attenuation of the LPG bands.

LPG is very useful as a sensor when the refractive index of the external medium changes. The change in ambient index changes the effective index of the cladding mode and will lead to wavelength shifts of the resonance dips in the LPG transmission spectrum. Similar advantageous effects of refractive indexed dominated sensor response were also reported for tilted and FBGs in tapered fibers.

In general the bandwidth, the range of wavelengths, used by FBG interrogators is generally 60 nm and in special cases 140 nm. As an example, if the grating can be made to have a total spectrum 10 nm, then 6 FBGs with different wavelengths can be placed in a length of fiber in the general case of a 60 nm bandwidth interrogator. In case of the 140 nm interrogator, 14 FBG can be placed. As such, there cannot be more then 6 (or 14) FBGs with different wavelengths because otherwise they will overlap spectrally and it will be difficult to decipher which one is which when there is an oil spill. While it is possible to write multiple FBGs with the same wavelength on a fiber length, but then their spectra will also overlap, and render the point location of the leak too broad to be of practical use.

These constraints due to the bandwidth restriction may limit utilization of the LPG or TFBG as taught in the Tailor patent application. The pipeline distances commonly run from 10 km to 1000 km. Therefore, an optical fiber sensor design used for monitoring should be capable of traversing 1 km-10 km and preferably >100 km with the laser source and the interrogator and the overall architecture of the deployment being functional and economic.

For example, to monitor a 1 km of pipe with individual gratings with a bandwidth of 10 nm and using a special interrogator having a bandwidth of 140 nm, then there will be a maximum of 14 gratings over the 1 km distance. This means that the grating will be 71 km apart. Therefore if an oil spill occurred somewhere between two gratings, it would likely go undetected. Tailor anticipated this problem and taught the idea of using multiple fibers, with the staggered spacing of the grating in order to obtain better location resolution. Though this may work well, it adds complexity in cable bundle design, logistics of spacing and multiplexing equipment.

It continues to be desirable to have a hydrocarbon leak monitoring system that truly detects the hydrocarbon and can be deployed over long distances with high spatial resolution, and most importantly at economical cost.

The Avon's patent used oil sensitive silicone coating as a coating on the entire fiber length, but requiring a pair of source/detector for each segment used to provide location information, while Tailor used silicone coating on the FBG only. Both these systems are innovative, however create certain technical hurdles which would be desirable to overcome.

### SUMMARY OF THE INVENTION

In one aspect, is provided an optical conduit comprising at least one fiber optic portion and at least one sensor portion, whereby a light transmitted through the optical conduit passes through both the fiber optic portion and the sensor portion in a sequential manner, said sensor portion having a first refractive index and a first light transmissibility when in contact with air, and a second refractive index and a second light transmissibility when in contact with a substance other than air, wherein the first refractive index is similar or identical to the fiber optic cable refractive index and the first light transmissibility allows all or a significant portion of light of a desired wavelength therethrough, and wherein the second light transmissibility is different than the first light transmissibility or the second refractive index is different from the first refractive index.

According to certain embodiments, the at least one fiber optic portion comprises a plurality of fiber optic portions, and the at least one sensor portion comprises a plurality of sensor portions, wherein the optical conduit is configured so that each of the plurality of fiber optic portions alternate with each of the plurality of sensor portions.

According to certain embodiments, the substance other than air is an aqueous substance, for example, a hydrocarbon such as an oil.

According to certain embodiments, the sensor portion is made from a material having a first refractive index within 0.1 refractive index units of the fiber optic cable refractive index and an absorption coefficient of less than 0.1/mm.

According to certain embodiments, the sensor portion is made from a material selected from the group comprising silicone, polystyrene and polyvinyl acetate.

According to certain embodiments, each of the at least one fiber optic portion are between 1 m and 100 km in length, preferably between 1 m and 10 km in length, more preferably between 1 m and 2 km in length.

According to certain embodiments, each of the at least one fiber optic portion are between 30 and 50 m in length.

According to certain embodiments, each of the at least one sensor portion are between 5 and 1000 micrometers in length, preferably between 50 and 500 micrometers in length, most preferably about 250 micrometers in length.

According to a further aspect of the present invention is provided a method of manufacturing an optical conduit of any one of the preceding claims, comprising: providing two lengths of fiber optic cable; Providing a ceramic ferrule with a polished endface to terminate each length of cable on both ends; Attaching a mating sleeve to one of the ferrules on one end of each of the two lengths of fiber optic cable; Mating the two lengths of fiber cable by inserting the other end of the each fiber cable into the mating adapter such as to leave a gap between the endfaces of the ferrules; Adding the sensor material to the gap between the ends in a manner that it fills the gap and adheres to the ends.

### BRIEF DESCRIPTION OF FIGURES

FIG. 1 is a schematic depiction of a fiber optic cable of the prior art.

FIG. 2 is a depiction of the light shift that occurs in a strained FBG sensor as understood in the prior art.

FIG. 3 is a schematic cross section of a fiber optic cable in a certain embodiment of the current invention.

FIG. 4 is a schematic cross section of a fiber optic cable in a further embodiment of the current invention.

FIG. 5 is a schematic cross section of a fiber optic cable in a further embodiment of the current invention.

FIG. 6 is a simplified general schematic of a fiber optic cable in certain embodiments of the present invention.

FIG. 7A is a schematic depiction a fiber optic cable of a certain embodiment of the present invention in the context of an oil leak in a hydrocarbon pipeline.

FIG. 7B and 7C are schematic depictions of fiber optic cables of various embodiments of the present invention in the context of an oil leak in an oil tank.

FIG. 8A-C and 9A-B show photographs of gap-connectors utilized in the making of the fiber optic cable of certain embodiments of the present invention.

FIG. 10 shows a photograph of a gap-connector covering and protecting a silicone “bead” between two sections of fiber optic cable.

FIG. 11 shows reflected power over the length of a fiber optic cable, as measured for a fiber optic cable sensor having a silicone bead at 3 m, in water, air, and oil.

FIG. 12A and 12B show gap peak power over time, and peak power over distance for various times, for a sensor of the present invention contacted with water (control) or oil.

FIG. 13 shows a schematic representation of a bundled fiber optic cable sensor of certain embodiments of the present invention, with staggered sensors.

FIG. 14 is a further depiction of a bundled fiber optic cable sensor of certain embodiments of the present invention.

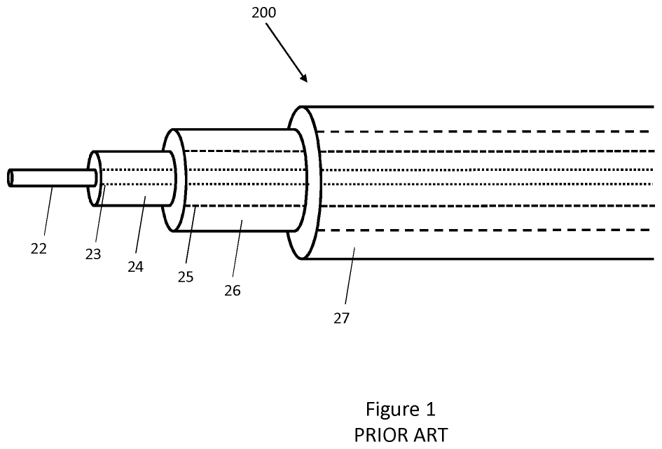

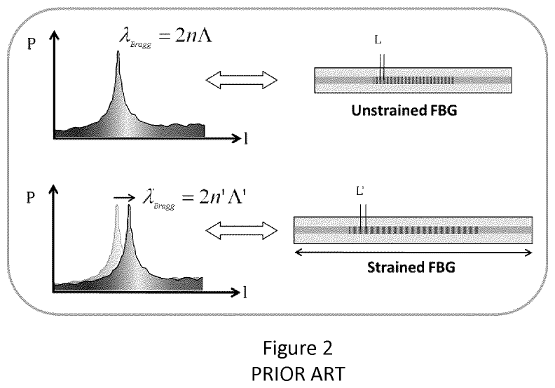

### DETAILED DESCRIPTION

Described is a new fiber optic sensor for oil leak detection. It can be used with, or without FBGs. The new fiber optic sensor comprises discrete lengths of fiber optic cable, connected together with a material which is generally transparent to light and with similar refractive index as the fiber optic cable, but having properties wherein the transparency and/or the refractive index of the material changes when the material comes into contact with a substance desired to be detected. In certain embodiments, and as exemplified herein, the material is a silicone “plug” or “bead” and the substance desired to be detected is a hydrocarbon, for example, an oil. The silicone is transparent to light and has a similar refractive index (RI) as the glass, around 1.45. Oil will soften and/or swell the silicone thereby changing the RI. The change in the RI of the silicone interferes with the light transmission through the core. This loss in the signal transmission at the silicone joint is reflected back using Optical Time Domain Reflectometry (OTDR), which can then determine the location of the triggered sensor by measuring the time delay for the return of reflected short pulses of light emitted at the entrance of the fiber.

OTDR is therefore able to detect the exact location of the “bead” that is affected.

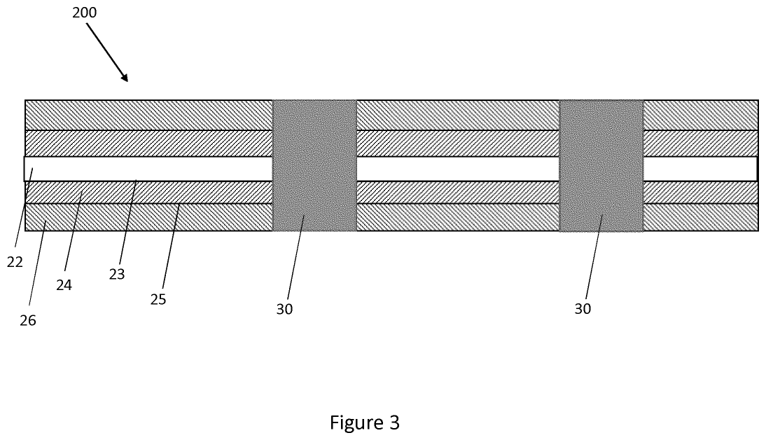

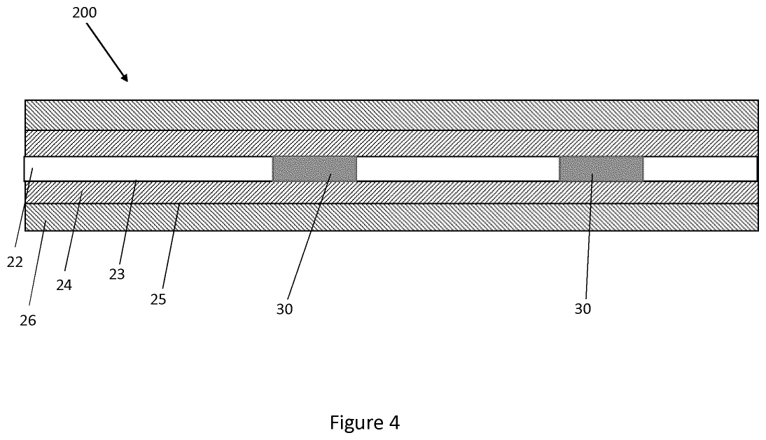

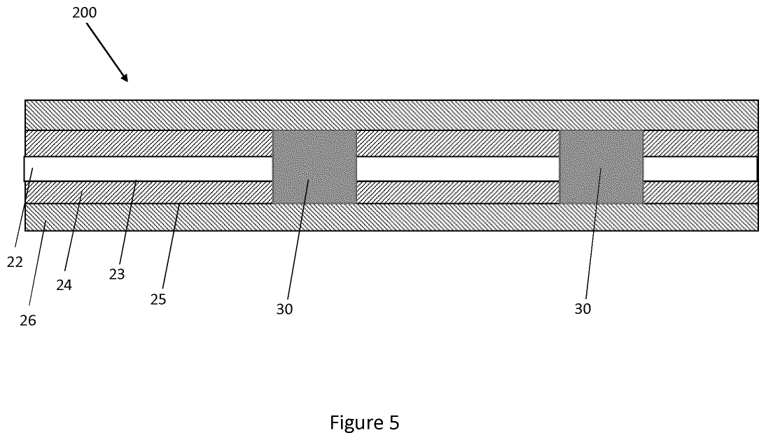

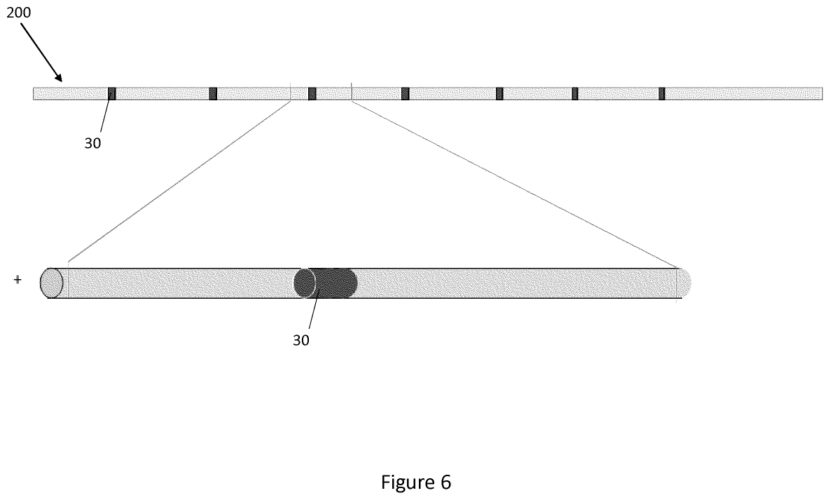

See, for example, FIG. 3, which shows a schematic cross section of a fiber optic cable of the current invention. Fiber optic cable 200 comprises an inner core 22, a core/cladding interface 23, cladding 24, a buffer coating 26 and an outer protective sheath 27, as previously described. Interspersed along fiber optic cable 200 comprises one or more, in many embodiments a plurality, of what the inventor has termed “beads” 30 of silicone material. The beads may intersect the entire fiber optic cable (as shown in FIG. 3), may intersect only the inner core 22 (as shown in FIG. 4), or may intersect the core and cladding (as shown in FIG. 5) or any part of the cable, so long as the core 22 is intersected. All of these possibilities is shown in a more simplistic form, for the purposes of illustration, as one general schematic in FIG. 6.

Preferably, the silicone material is of a grade that has high optical clarity and a refractive index matching the fiber core. In this manner, light transmission loss at the joint can be minimised. There may be attenuation at the joint as the distance increases away from the OTDR, however these attenuated values are likely slight, and would in any event be part of the baseline when the entire system is deployed and calibrated. Changes resulting from the oil presence at a given sensor can be picked by measuring a light signal, and changes thereof, transmitted through the cable; if it is desired to determine the location of the oil presence, an OTDR may be used. The OTDR is a laser source that sends a short pulse of light and waits for an echo to return. If there is an interruption at any of the sensors, the echo will be reflected back. By timing the return, the OTDR can compute the distance of the sensor and pinpoint the location. If there was no splice and no silicone sensor in the fiber, meaning a normal intact fiber, there would still be slight decline in the transmission due to scattering from the molecules of the glass, referred to as the Rayleigh effect. The presence of silicone sensor would slightly increase the decline, however our measurements has shown this to be minimal.

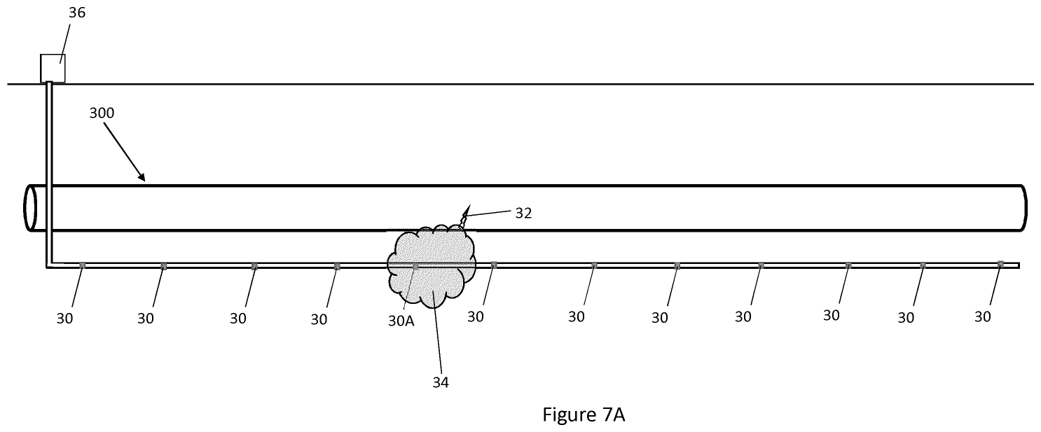

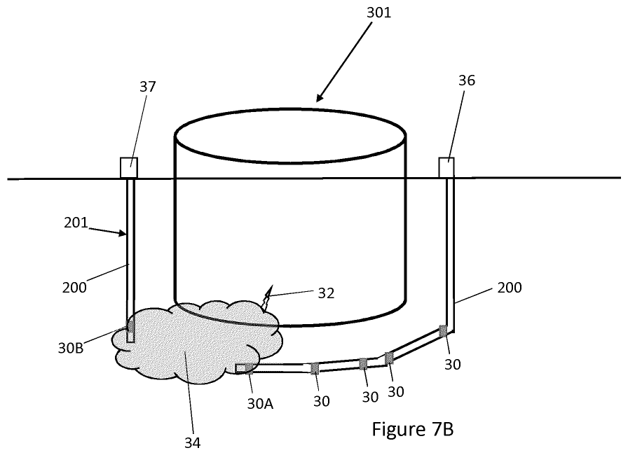

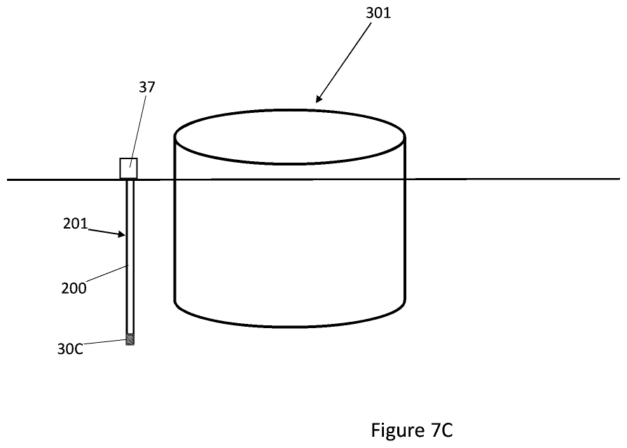

FIG. 7A is a schematic illustration of a cable sensor of the present invention subjected to a hydrocarbon leak from an underground pipeline.

Fiber optic cable 200 containing silicone beads 30, 30A interspersed about 10 meter apart is run generally in parallel to and generally adjacent to an underground oil or gas pipeline 300. Fiber optic cable 200 is operably connected to an optical time domain reflectometer 36, which is typically (and as shown) located above ground, and is capable of sending a light signal through the fiber optic cable 200. The light signal continues along fiber optic cable 200 since the silicone beads 30 have high optical clarity and a refractive index generally matching the optical core. As illustrated, pipeline 30 has a crack or fracture 32, which leads to an oil leak 34 from the pipeline 30. A silicone bead 30A is in the path of the oil leak 34. When the silicone bead 30A comes into contact with the oil leak 34, it softens and swells, and its opacity and/or refractive index changes significantly. The silicone bead 30A is therefore no longer (or less) able to transmit light signal, and bounces some of that signal back to the optical time domain reflectometer 36. The bouncing back of signal is an indication that there is an oil leak 34 from the pipeline 300. The optical time domain reflectometer 36 can use the time difference between signal and bounce-back to determine the distance between it and the affected silicone bead 30A, which provides the user with both the knowledge that there is an oil leak, and the leak location along the fiber optic cable 200. The OTDR 36 can, in some exemplifications, transmit a signal to a second location, for example, wirelessly through the cloud to a monitoring station miles away, even anywhere in the world.

As would be readily evident, fiber optic cable 200 having silicone beads 30 interspersed about 1 km apart will be able to provide location information for a leak to a resolution of about 1 km. Fiber optic cable 200 can be made with silicone beads 30 interspersed at any interval, to provide the desired resolution. Alternatively, for example, multiple fiber optic cables 200 each with silicone beads 30 at 10 meters apart may be staggered to provide higher resolution. Such a system may be useful, for example, for use in oil gathering lines, which are typically less than or about 2 km in length and which connect oil wells to gathering stations, or from gathering stations to a main pipeline.

FIG. 7B is a schematic illustration of two cable sensors of the present invention, installed to detect hydrocarbon leaks from an oil tank.

Similarly to the application shown in FIG. 7A, a fiber optic cable 200 containing silicone beads 30 can be placed underneath an oil tank, for example an above ground, buried, or (as shown) partially buried oil tank 301. The fiber optic cable 200 is operably connected to an optical time domain reflectometer 36 which is typically (and as shown) located above ground, and is capable of sending a light signal through the fiber optic cable 200. The light signal continues along fiber optic cable 200 since the silicone beads 30 have high optical clarity and a refractive index generally matching the optical core. As illustrated, oil tank 301 has a crack or fracture 32, which leads to an oil leak 34 from the oil tank 301. A silicone bead 30A is in the path of the oil leak 34. When the silicone bead 30A comes into contact with the oil leak 34, it softens and swells, and its opacity and/or refractive index changes significantly. The silicone bead 30A is therefore no longer (or less) able to transmit light signal, and bounces some of that signal back to the optical time domain reflectometer 36. The bouncing back of signal is an indication that there is an oil leak 34 from the oil tank 301. The optical time domain reflectometer 36 can use the time difference between signal and bounce-back to determine the distance between it and the affected silicone bead 30A, which provides the user with both the knowledge that there is an oil leak, and the leak location along the fiber optic cable 200. The OTDR 36 can, in some exemplifications, transmit a signal to a second location, for example, wirelessly through the cloud to a monitoring station miles away.

As might be appreciated, for certain applications, such as small and discrete oil tanks, location information may not be as critical. As such, a much cheaper oil sensor can be implemented according to the invention, as also shown in a “dipstick” style sensor 201, also depicted in FIG. 7B. Dipstick sensor 201 also comprises fiber optic cable 200 and silicone bead 30B as previously described. However, in some embodiments, as little as one silicone bead 30B is sufficient (though more silicone beads can be interspersed as previously shown). The main difference between dipstick sensor 201 and other sensors of the present invention is that, since location information is not needed, the light source and measure does not need to be an OTDR. A much less expensive light source and detector 37 can be used, since the only measurement necessary is a change in the light signal. Thus dipstick sensors can be deployed very cheaply and effectively where point measurements or measurements without location information are desired.

Although the dipstick sensor 201 is shown with the silicone bead 30B having fiber optic cable on either side, it would be appreciated that a silicone bead 30C on the end of a fiber optic cable, as depicted in FIG. 7C, would also provide sensing of a hydrocarbon leak, and may be much less expensive to manufacture.

Although the examples herein are all shown with silicone beads, it would be understood that the beads can be made of any suitable material, and materials with different properties can be utilized depending on the substance one wishes to detect. Suitable materials are those which (1) are able to adhere or be adhered to the fiber optic core; (2) are optically clear enough to allow transmission of all or most of the light at the wavelength of the interrogation, or clear enough to allow at least some of the light through; (3) have a refractive index identical or similar enough to the fiber optic core to allow transmission of the light through the material with little or no bounce-back or signal loss; and (4) have optical properties (clarity and/or refractive index) which change when in the presence of the substance to be detected.

Where the substance to be detected is oil, silicone is an excellent material, as it has good optical properties, can have a refractive index which matches or nearly matches that of the inner core, has adhesive properties so that it can adhere to the fiber optic core, and changes properties when it comes into contact with hydrocarbon. Other suitable materials for the bead where the substance to be detected is oil may include certain polystyrenes. Where the substance to be detected is water, a suitable material for the bead may be polyvinyl acetate (PVA). Interestingly, the optical properties of polyvinyl acetate do not appear to change when in contact with oil, and the optical properties of silicone do not appear to change when in contact with water; accordingly, oil-specific sensors which do not react to water, and water-specific sensors which do not react to oil, are possible, and may be desirable in certain applications.

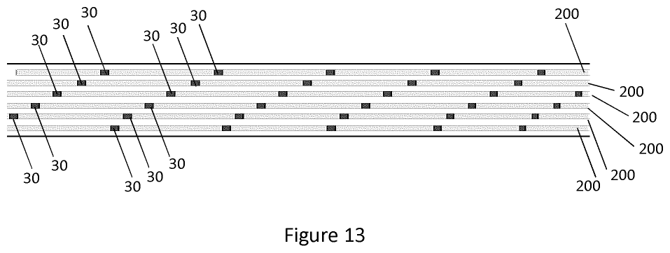

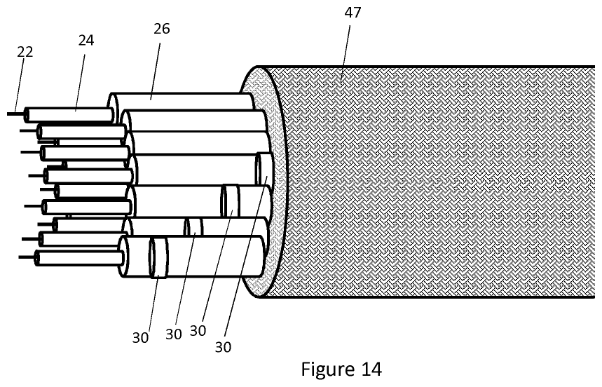

In certain applications, it may be desirable to bundle the two together, and/or to bundle these novel sensors with other, known, fiber optic sensors, such as those that are able to detect changes in temperature, pressure, or strain. Such multi-sensors may be within a single fiber optic bundle, or they may be separate fiber optic cables installed together. Bundling of cables in this manner may also help increase resolution, or distance, or both. An example of such a sensor fiber optic bundle can be seen (in two different schematic views) in FIGS. 13 and 14.

The design of packaging of the cables for leak detection is important for field deployment. There are several considerations that would dictate such design. One of key variables for the pipeline monitoring is the length of the pipeline and distance the light transmission has to travel through the fiber. The pipeline could be 10 km, 100 km or even 1000 km. For practical and economic reasons, one would want to minimize the control hubs for laser interrogator along the pipeline. In practice, there will be a limit to how many of the necklace sensors that can be installed on the fiber length, before the attenuation losses become problematic for measurements. With the FBG based leak detection fiber system, one could install around a dozen or so sensors for 140 nm bandwidth interrogator. Such interrogators could cost $50,000 to $100,000. This makes it commercially unviable to deploy such a system over longer distances. Our investigation has shown that with the necklace design system, there can be 100's of silicone joints before the signal attenuation could become a problem, a far superior system to the FBG design. In addition, relatively simple OTDR systems can be used, which are much less expensive than the interrogators used for FBG interrogation.

Using such a staggered sensors design, one could use dozens of fibers cables to obtain narrow spatial resolution, as the sensor could be located 1 m apart or 5 m apart as desired, without the problem of attenuation loss at the silicone joints. A single OTDR, costing $1000-$10,000 could be used to monitor multiple staggered fiber strands to cover tens or 100's of kilometer of pipeline using a multiplexing machine, such as a single mode optical fiber switch; for example, the Polatis 6000i (Viavi) has port counts up to 192×192 and switch times measured in the milliseconds. The fiber strands could be interrogated sequentially, on a time scale of seconds to a few minutes per total system scan.

It is desirable, in leak detection systems, to have multiple redundancies in the sensing system. Accordingly, it is often desirable to utilize multiple optical cables in the event that one of the fibers becomes non-functional. In the bundled configuration as described above, having the multiple fibers would provide the desired redundancy feature. An additional redundancy may be provided by having an interrogation system on both ends of the pipeline length to be monitored.

The protective outer jacket 47 shown in FIG. 14 would be permeable to hydrocarbon, for example jacket that is perforated or braided. It could also be a perforated conduit made from a metal such as steel or made from plastic. The bundle jacket may also be perforated, braided, or a mesh and that is placed inside a perforated conduit.

It can appreciated by someone skilled art, that one may incorporate fiber cores which act as control cores, or distributed sensors, such as DTS (distributed temperature sensor) or DAS (distributed acoustics sensor) that can traverse long distances. This would require a different interrogator, but such hybrid system could provide independent data of the presence of hydrocarbon as well the temperature and movement/vibration/acoustics that could all be incorporated into an AI system for a comprehensive data analysis and the event characterization.

It is envisaged that the necklace fiber system would be deployed alongside the pipeline, either strapped to outer pipe surface or placed in the vicinity of pipe, 1 cm to 100 cm away. The optimum location to place the cable directly underneath (the 6 o'clock position), since generally the spilt oil will have initial tendency to flow downwards and then usually sideways. Depending on the soil properties, at some point the soil will become saturated, and then the oil will move upwards. The cable could also be placed at higher positions around the pipe at say 3, 9 or 12 o'clock positions.

In one embodiment, for example, for detection of leaks along a 2 km pipeline, a necklace fiber system may comprise about 5-6 fiber optic cables, each 2 km long and running generally parallel to the pipeline, and each with about 80 sensor “beads”, generally equidistant to one another. The 5 fiber optic cables would be configured in a staggered configuration, much like as pictured in FIG. 13, so that the 80 beads would, in effect, provide the resolution of 400-480 beads (or sensor points) along the 2 km, therefore providing a resolution of about 4.2-5 meters.

While the initial aim of the development of the necklace design fiber optic system was for the detection of hydrocarbons, particular oil, it was discovered that the unique characteristics of the necklace design with the chemical sensitive “bead” in the joint would lend itself to detecting myriads of materials, liquids and gases. The key consideration in expanding the concept to other sensing materials in place of the silicone is the ability of the gap material to have optical properties and refractive index that would permit light transmission with acceptable signal attenuation, and that the gap material undergoes a significant change in RI upon contact with the targeted gas or liquid. In one example, the joint gap can be filled with polyvinyl alcohol (PVA) resin. PVA is susceptible to the presence of water, it softens and tends to dissolve in water. This would create big disruption of the signal at the joint. The RI of PVA is 1.4839. This is somewhat higher than the RI of glass at 1.4475. There are many techniques published that shows how to reduce the RI of PVA. One example is shown in “Miscibility studies of sodium alginate/polyvinyl alcohol blend in water by viscosity, ultrasonic, and refractive index methods”, Sateesh R. Prakash. In this paper, he teaches reducing the RI of PVA by mixing with a similar miscible polymer having lower melt index. In this experiment he uses a blend sodium alginate/polyvinyl alcohol. There is also possibility of adjusting the RI of core glass by various doping techniques.

### EXAMPLE 1

A fiber optic cable having a single silicone bead was made, as follows. Splicing of glass core is routinely carried out in the industry, with negligible signal loss in the order of 1-2 db. We used standard splicing equipment to align two ends of two fiber optic cables. Silicone having a refractive index which closely matched the fiber optic cable was molded into a gap between the two aligned cable ends. We found that this provided a very stable and reliable connection, with a typical signal loss of less than 3 db, for example 1-3 db or even 0.3-1 db.

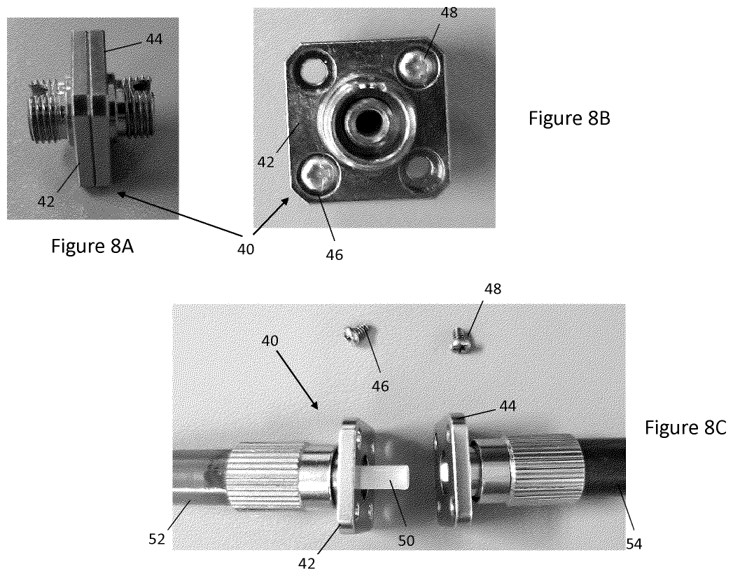

For example, commercially available gap-connectors were utilized and are shown in FIGS. 8A-C. Gap-connectors 40 comprise mating adapters 42, 44, which are commercially available multimode fiber-mating adapters (Fiber Instrument Sales, part number F18300SSC25) in which the multimode metal alignment sleeve was replaced by a single mode ceramic alignment split sleeve 50 (Fiber Instrument Sales, part number F18300SSC25). Sheathed fiber optic cables 52, 54 were each inserted into and fixed to one half of the mating adapter (42, 44, respectively) with ceramic sleeve 50 and two screws 46, 48 were used to secure them together in a precise alignment. A drop of silicone was injected into the 10 μm gap so that it flowed through the slot in the ceramic sleeve 50 and into the gap between the two connectors. Upon curing, the silicone bonded to the fiber cores, essentially re-forming a continuous fiber core for light transmission, with a very stable and secure connection. This method was essentially a molding process, inside the connector. FIG. 8A is a photograph of a side view of such a connector; FIG. 8B is the end view thereof. FIG. 8C shows the connector in an open state, connected to two fiber optic cables.

An alternate manufacturing method is shown in FIG. 9A-B. Here, similarly to the method shown in FIG. 8A-C, a commercially available gap connector 40 was used. However, instead of injecting silicone within a sleeve which covered the two fiber optic cores, a 0.25 mm thin metal plate 56 was inserted between the mating sleeves 42, 44 before the mating sleeve screws 46, 48 were fastened. The thin metal plate 56 has an aperture 58 into which silicone can be added; the silicone thus adheres to and forms an optical conduit with, the inner cores of fiber optic cables 52, 54. In certain embodiments, plate 56 can also contain screw apertures 60 and be therewith affixed to mating sleeves 42, 44; in other embodiments (not shown), plate 56 is of a size that it can fit between the screws and is friction fit in place; in such embodiments, the plate may be removed after the silicone has set, if desired. Though a plate 56 of 0.25 mm was used, a plate of different thickness, for example, anywhere from 5 to 500 micrometers, could be used to form sensor beads of such desired length.

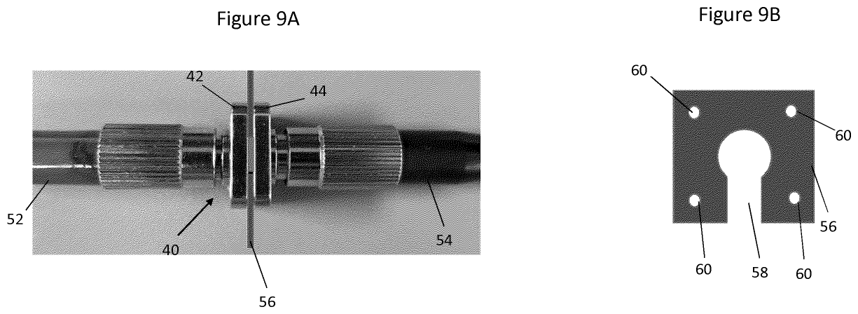

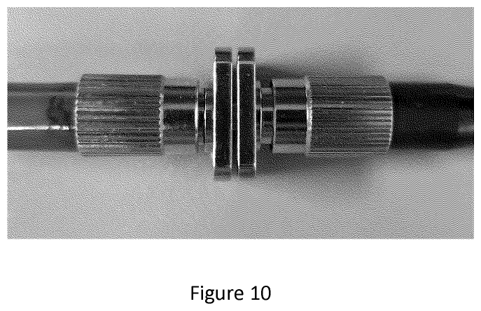

FIG. 10 shows a connector, fully assembled, having a silicone bead between two cable inner cores, forming a continuous light conduit.

The metal connector described above is for illustration purposes only. Person skilled in art can design the packaging in many different ways to suit the application, the optical fiber deployment and manufacturing method. For example, the connectors could be made from ceramic or rigid plastic such as Nylon with a snap-fit design, so that the manufacturing can be automated. They could also be made in small cross-section instead of the large metal flanges shown in the illustration.

### EXAMPLE 2: OIL SENSITIVE SENSOR AT 3 M

An optical fiber was constructed with a single silicone bead (sensor) utilizing the method of Example 1, and attached to an OTDR instrument. The optical fiber was configured such that there was a 3 meter line of fiber optic cable between the OTDR instrument and the bead.

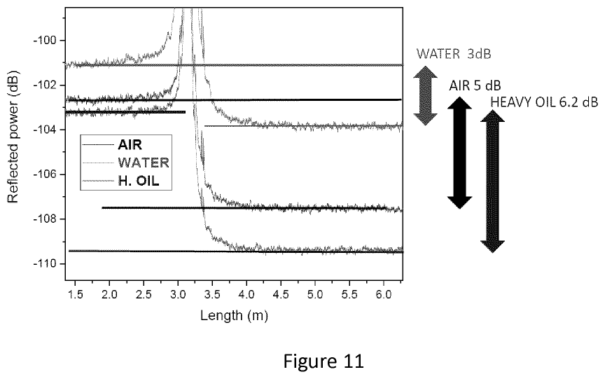

The OTDR instrument measured reflected power as the silicone bead was subjected to three different environmental conditions: the silicone bead (and the portion of the sensor surrounding said silicone bead) was placed in water, air, and oil respectively, and the readings were measured. It was found that the reflected power for oil was 6.3 dB—significantly greater than that for water or air. The location of the sensor (3 m from the OTDR instrument) was also accurately determined. The results were shown in FIG. 11.

### EXAMPLE 3: OIL SENSITIVE SENSOR AT 1.7 KM

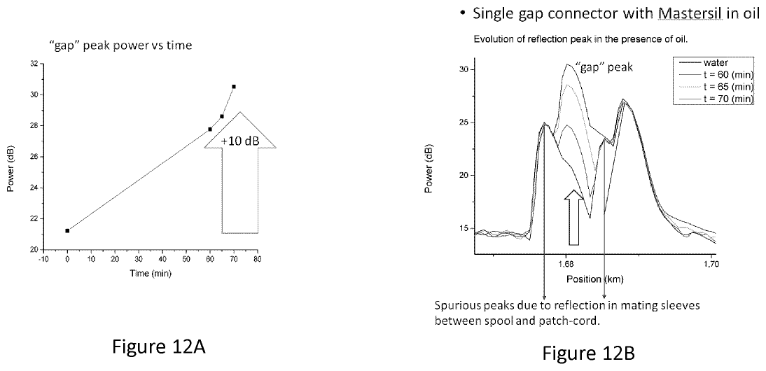

The experiment of Example 2 was repeated, this time with 1.68 km of fiber optic cable between the OTDR instrument and the silicone bead. The first test was done with water applied to the sensor, which resulted in a signal in the 16-21 dB range at 1.7 km. When the sensor was immersed in light oil, the signal peak jumped to 25 dB after 60 minutes, and to 28 db after 65 minutes. It peaked to 31 dB after 70 minutes. The graph shown at FIG. 12A below ilustrates the rise in the power as the oil got absorbed into the sensor with time peaking at 31 dB after 70 minutes. This is significant, since in real situation, the oil could surround the sensor cable for hours or days with slow leak, and getting a response within hours or even days after the leak starting is extremely useful, in order to undertake remedial measures.

The data is depicted in FIG. 12B, which shows the peak power vs time with immersion in oil. There is delta of 10 dB in power shift as result of the oil contact. This is a very significant change, and easily decipherable.

1. An optical conduit comprising at least one fiber optic portion and at least one sensor portion, whereby a light transmitted through the optical conduit passes through both the fiber optic portion and the sensor portion in a sequential manner, said sensor portion having a first refractive index and a first light transmissibility when in contact with air, and a second refractive index and a second light transmissibility when in contact with a substance other than air, wherein the first refractive index is similar or identical to the fiber optic cable refractive index and the first light transmissibility allows all or a significant portion of light of a desired wavelength therethrough, and wherein the second light transmissibility is different than the first light transmissibility or the second refractive index is different from the first refractive index.

2. The optical conduit of claim 1 wherein the at least one fiber optic portion comprises a plurality of fiber optic portions, and the at least one sensor portion comprises a plurality of sensor portions, wherein the optical conduit is configured so that each of the plurality of fiber optic portions alternate with each of the plurality of sensor portions.

3. The optical conduit of claim 1 wherein the substance other than air is an aqueous substance.

4. The optical conduit of claim 1 wherein the substance other than air is a hydrocarbon.

5. The optical conduit of claim 4 wherein the hydrocarbon is an oil.

6. The optical conduit of claim 1 wherein the sensor portion is made from a material having a first refractive index within 0.1 refractive index units of the fiber optic cable refractive index and an absorption coefficient of less than 0.1/mm.

7. The optical conduit of claim 1 wherein the sensor portion is made from a material selected from the group comprising silicone, polystyrene and polyvinyl acetate.

8. The optical conduit of claim 1 wherein each of the at least one fiber optic portion are between 1 m and 100 km in length, preferably between 1 m and 10 km in length, more preferably between 1 m and 2 km in length.

9. The optical conduit of claim 7 wherein each of the at least one fiber optic portion are between 30 and 50 m in length.

10. The optical conduit of claim 1 wherein each of the at least one sensor portion are between 5 and 1000 micrometers in length, preferably between 50 and 500 micrometers in length, most preferably about 250 micrometers in length.

11. A method of manufacturing an optical conduit of claim 1, comprising:
a. Providing two lengths of fiber optic cable;
b. Providing a ceramic ferrule with a polished endface to terminate each length of cable on both ends;
c. Attaching a mating sleeve to one of the ferrules on one end of each of the two lengths of fiber optic cable;
d. Mating the two lengths of fiber cable by inserting the other end of the each fiber cable into the mating adapter such as to leave a gap between the endfaces of the ferrules;
e. Adding the sensor material to the gap between the ends in a manner that it fills the gap and adheres to the ends.
